(19) United States
(12) Patent Application Publication
(10) Pub. No.: US 2016/0088974 A1
(43) Pub. Date: Mar. 31, 2016

(54) Apparatus for Roasting Corn

(71) Applicant: Linhbao Tran, Bellevue, WA (US)

(72) Inventor: Linhbao Tran, Bellevue, WA (US)

(21) Appl. No.: 14/499,089

(22) Filed: Sep. 27, 2014

(51) Int. Cl. A47J 37/06

(52) U.S. Cl. CPC A47J 37/0688

(57) ABSTRACT

The present invention relates to an apparatus having one or more slots for accommodating one or more ears of corns for roasting by an electrical heat source. The apparatus is compact, energy efficient, and able to produce uniformly roasted ears of corn.

### TECHNICAL FIELD

This invention relates to an apparatus having one or more slots for accommodating one or more ears of corn to be roasted by an electrical heat source.

### BACKGROUND ART

Roasting or grilling ears of corn for many years have relied on household appliance such as electrical or gas ovens, large outdoor grills, or open fire pit. For the household oven, ears of corn may be placed on a planar support rack and the heat source comes from below and/or above the rack. Outdoor grills also have similar construction of a planar food support rack and a heat source, typically coming from below. For an open fire pit, ear of corn are typically wrap in aluminum foil and placed directly onto the hot coal within the pit, or one could stick the ear of corn on a long rod to be held by a consumer over the fire pit.

### SUMMARY OF INVENTION

### Technical Problem

Currently, roasting or grilling ears of corn requires typical cooking appliances such as an oven or a grill, both of which are designed to cook food other than ear of corn. Hence, these appliances consume an amount of energy that is larger than necessary for roasting ears of corn. In addition, due to not-intended usage, user intervention is required, such as turning over the partially cooked ear of corn in order to produce uniformly roasted ear of corn. Other appliance such as outdoor grills, typically found at fairground, are large and can roast up to hundreds ears of corn at the same time. However, these are expensive and are too bulky for household usage.

### Solution to the Problem

The present invention provides a roasting apparatus having one or more slots for accommodating one or more ears of corn, characterized in the said apparatus is provided with slot having cylindrical shape for holding ear of corn, and the said apparatus is provided with individual cylindrical shape heat source for each ear of corn.

### Advantageous Effects of Invention

The present invention provides a roasting apparatus that is energy efficient, is easy to use, is compact for kitchen countertop storage, facilitates uniform cooking, and avoids direct contact with hot food until the food is fully cooked.

The following descriptions of the drawings will show novel features and advantages in this invention.

### BRIEF DESCRIPTION OF DRAWINGS

FIG. 1 is the front perspective view of an embodiment of the present invention.

FIG. 2 is the back perspective view of an embodiment of the present invention.

FIG. 3 is the front view of an embodiment of the present invention.

FIG. 4 is the side view of an embodiment of the present invention.

FIGS. 5A and 5B are the top view and bottom view, respectively, of an embodiment of the present invention.

FIGS. 6A and 6B are front view and top view of the lid, respectively, of an embodiment of the present invention.

FIGS. 7A and 7B are perspective view and see through view of the heating element, respectively, of an embodiment of the present invention.

FIG. 8 is the perspective view of the support rack of an embodiment of the present invention.

### DESCRIPTION OF EMBODIMENTS

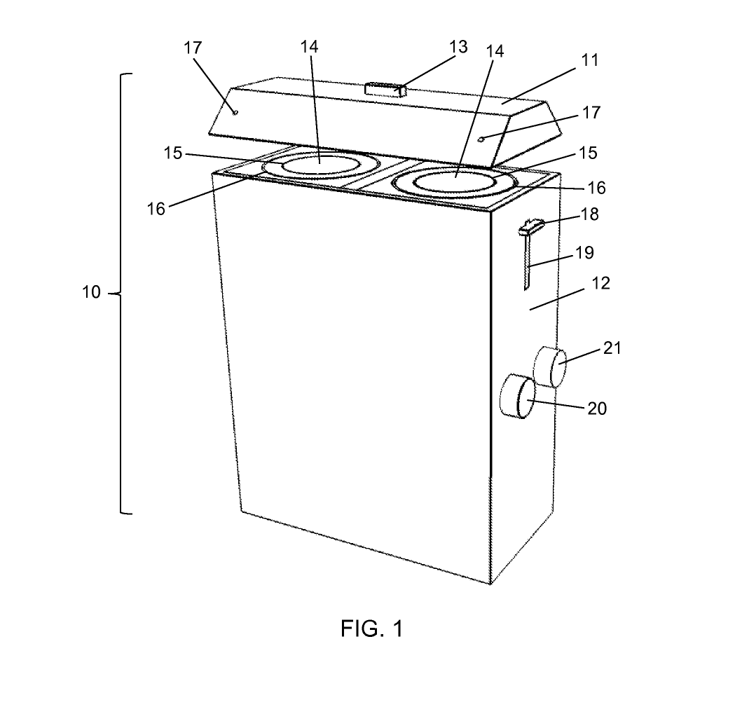

FIG. 1 is the front perspective view of an embodiment of the present invention, showing the roaster 10 comprises a housing 12 and a lid 11. The upper portion of the housing shows two slots 14 for accommodating one ear of corn each for roasting. It is also possible to provide the said apparatus with one slot 14 or more than one slot. Cylindrical shape rack support 15 is provided to hold said food item upright, and heating element 16 is provided for roasting said food item. Operating lever 18 when pressed down along the slit 19, lowers the said food holding tray and make electrical contact to activate heating element 16. The lid 11 comprises of a handle 13 and venting holes 17. The stop/cancel knob 20 is provided as controller to interrupt roasting operation. The knob 21 controls the darkness of the roasting said food item.

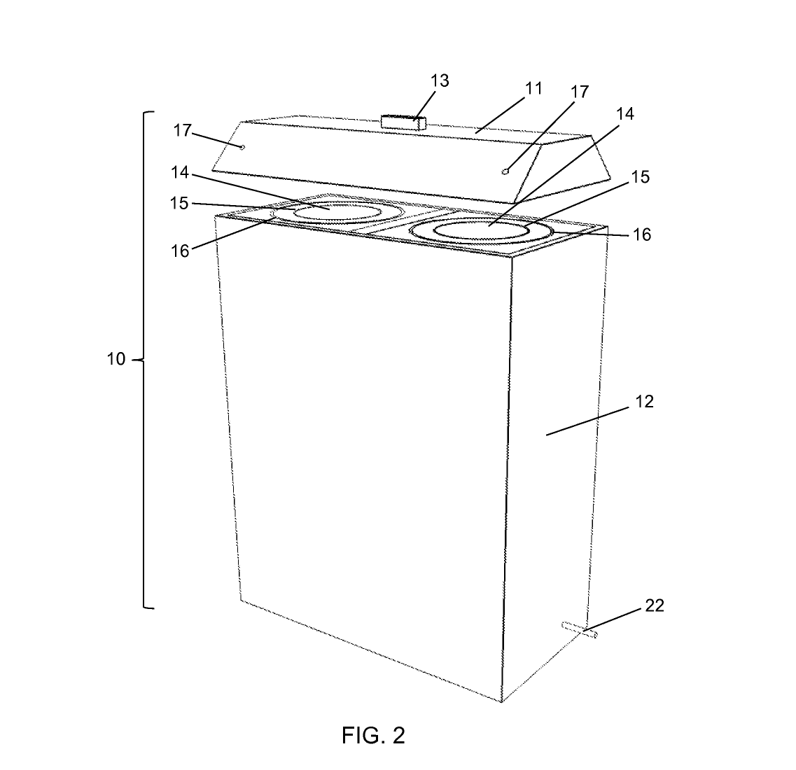

FIG. 2 is the back perspective view of an embodiment of the present invention. Heat source is electrical and is supplied through a cable 22. Other components are as described in FIG. 1.

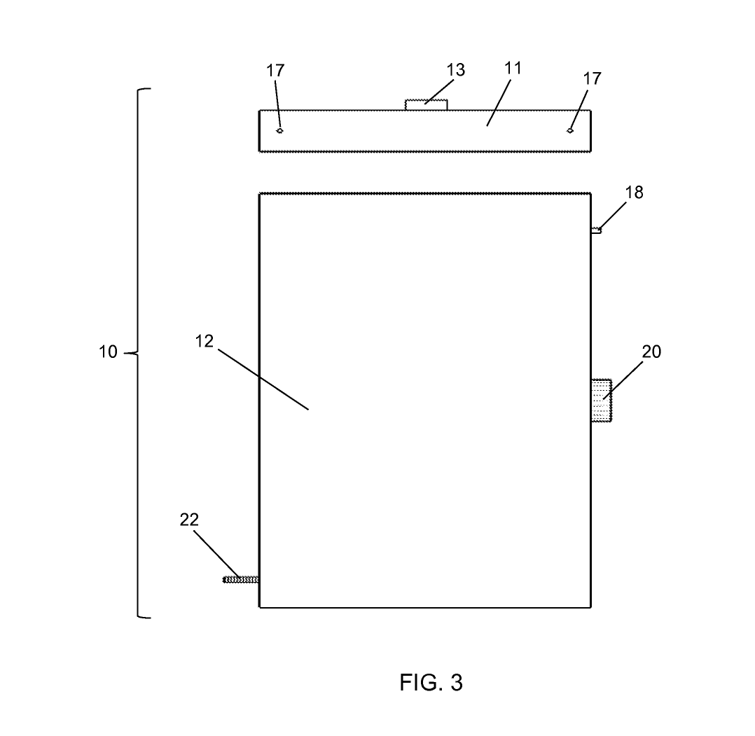

FIG. 3 is the front view of an embodiment of the present invention showing the housing 12, the lid 11, the vent holes 17, the lid handle 13, along with the stop/cancel knob as described in FIG. 1. The purpose of the vent holes is to release buildup of pressure within the housing as food item is being cooked.

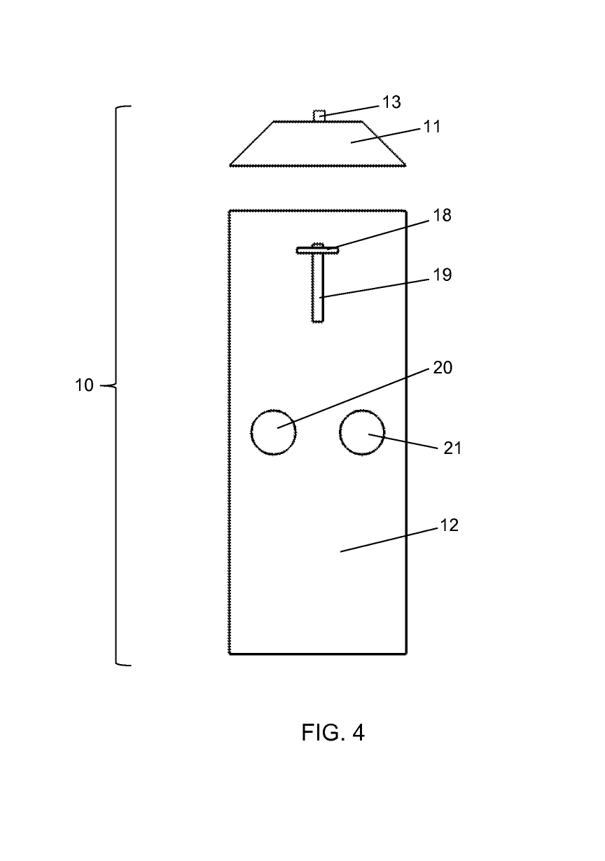

FIG. 4 is the side view of an embodiment of the present invention, showing components described in FIGS. 1 and 3.

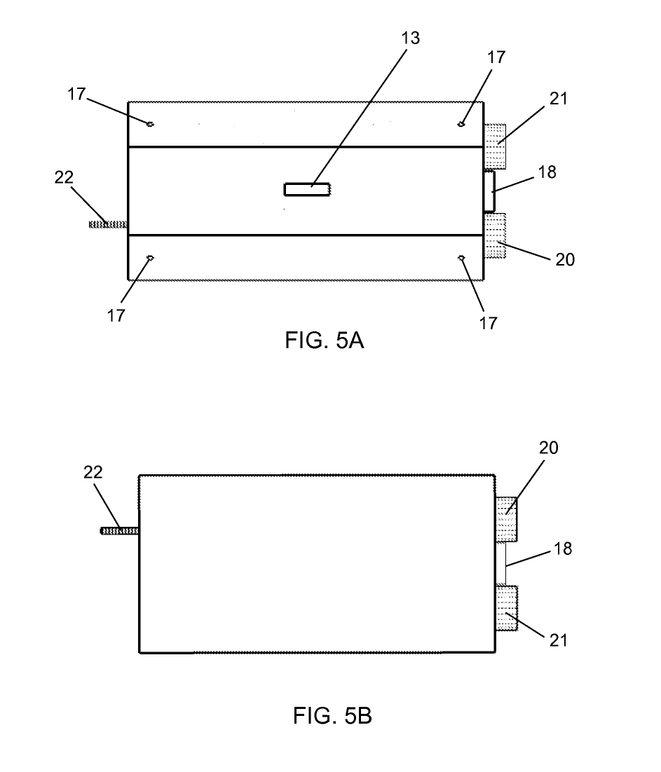

FIGS. 5A and 5B are the top view and bottom view, respectively, of an embodiment of the present invention, showing component as described in previous figures.

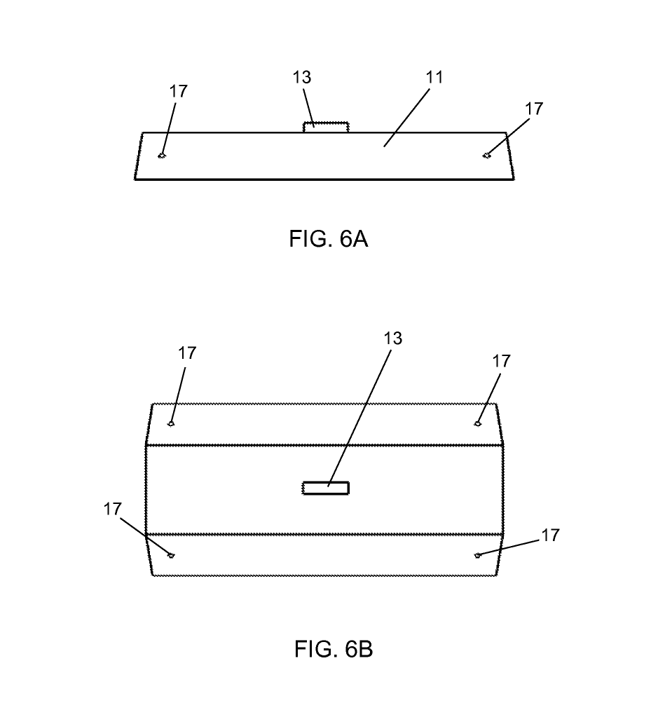

FIGS. 6A and 6B are front view and top view of the lid, respectively, of an embodiment of the present invention, serving dual purposes as keeping interior of roasting apparatus clean when in storage and as trapping heat for efficiency when in roasting operation. Handle 13 is provided for convenient as well as safety measure as the lid 11 gets hot while in use. Construction of the handle 13 uses low thermal conductivity material such as wood, whereas material for the lid 11 is generally made of metal. Vent holes 17 are provided to release the buildup of pressure within the housing as food is being cooked.

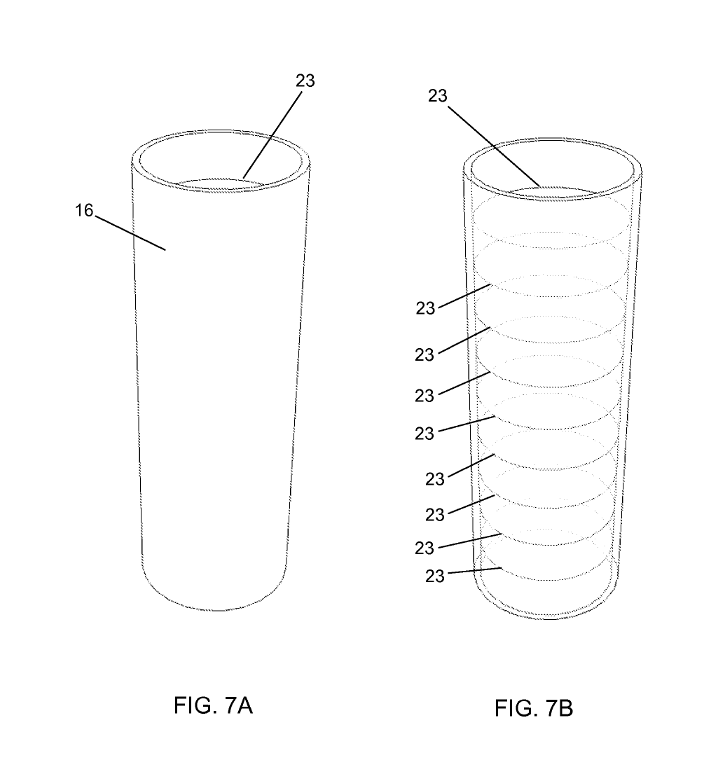

FIGS. 7A and 7B are perspective view and see through view of the heating element, respectively, of an embodiment of the present invention. The heating element 16 has cylindrical shape with high electrical resistant wire 23 wrapping around the inner side of the heating element 16. The heat source is electrical in nature, using wire 23 with high electrical resistive property of metal alloy. One possible construction of heating element 16 uses nichrome wire 23 wrapping around mica sheet 16. Such construction typically is used in household bread toaster appliance.

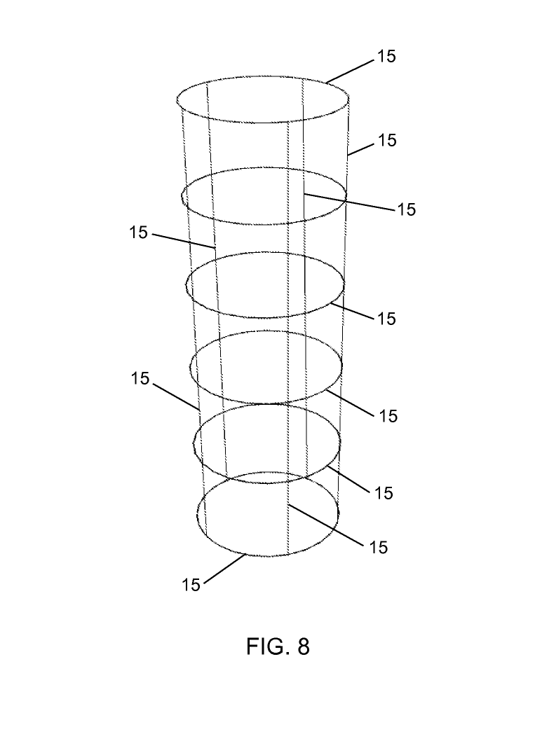

FIG. 8 shows a perspective view of a cylindrical shape support rack 15, having the purpose of holding the ear of corn upright. Stainless steel material is a general preferred material for construction of such support rack.

What is claimed is:

1. An apparatus for roasting ear of corn, comprising:
a main housing (12) with one or more slots to cook said food item;
a cylindrical shape support rack (15) for positioning said food item;
a cylindrical shape heating element (16) for individually roasting each said food item;
a control panel with stop/cancel knob (20) and darkness level knob (21);
a lid (11) for storage and for efficient roasting operation;

2. The roaster as claimed in 1, wherein said cylindrical support rack 15 for keeping said food item upright.

3. The roaster as claimed in 1, wherein said heating element 16 having cylindrical shape.

4. The roaster as claimed in 1, wherein said lid (11) has vent holes (17) to release buildup of pressure as the said food item is being cooked.
